(19) United States
(12) Patent Application Publication
(10) Pub. No.: US 2022/0243066 A1
(43) Pub. Date: Aug. 4, 2022

(54) UPGRADING ASPHALT BY INCORPORATION OF BIO-OILS

(71) Applicant: ExxonMobil Research and Engineering Company, Annandale, NJ (US)

(72) Inventors: John A. Noel, Sarnia (CA); Bennett J. Tardiff, Calgary (CA); Pavel Kriz, Sarnia (CA); Luis Jose Mendez, Rahway, NJ (US)

(21) Appl. No.: 17/649,078

(22) Filed: Jan. 27, 2022

Related U.S. Application Data
(60) Provisional application No. 63/143,092, filed on Jan. 29, 2021.

(51) Int. Cl. C08L 95/00; C10C 3/04

(52) U.S. Cl. CPC C08L 95/00; C08L 2555/64; C10C 3/04

(57) ABSTRACT

Asphalt compositions are provided that include bio-oil. Some compositions allow for upgrading of deasphalter rock to asphalt with a performance grade suitable for use as paving asphalt by addition of bio-oil to the deasphalter rock. Other compositions allow for upgrading of paving grade asphalt to roofing asphalt by addition of bio-oil followed by oxidation. Methods of forming asphalt compositions including bio-oil are also provided.

### CROSS-REFERENCE TO RELATED APPLICATIONS

This application claims the benefit of U.S. Provisional Application No. 63/143,092, filed on Jan. 29, 2021, the entire contents of which are incorporated herein by reference.

### FIELD

This invention relates to use of bio-oils to upgrade potential asphalt fractions into higher value asphalt materials. This can include using bio-oils to upgrade deasphalter rock to paving asphalt and using bio-oils to upgrade paving asphalt to roofing asphalt.

### BACKGROUND

Asphalt is one of the world's oldest engineering materials, having been used since the beginning of civilization. Asphalt is a strong, versatile and chemical-resistant binding material that adapts itself to a variety of uses. For example, asphalt is used to bind crushed stone and gravel into firm tough surfaces for roads, streets, and airport runways. Asphalt, also known as pitch, can be obtained from either natural deposits, or as a by-product of the petroleum industry. Natural asphalts were extensively used until the early 1900s. The discovery of refining asphalt from crude petroleum and the increasing popularity of the automobile served to greatly expand the asphalt industry.

Most of the petroleum asphalt produced today is used for road surfacing. Asphalt is also used for expansion joints and patches on concrete roads, as well as for airport runways, tennis courts, playgrounds, and floors in buildings. The asphalts used in these types of applications can be referred to as paving asphalts. Another major use of asphalt is in asphalt shingles and roll-roofing which is typically comprised of felt saturated with asphalt. The asphalt helps to preserve and waterproof the roofing material. This type of asphalt can be referred to as roofing asphalt. Roofing asphalt is typically viewed as a higher quality of asphalt, due in part to more restrictive specifications for one or more asphalt properties.

One major source of feedstock for asphalt production is vacuum tower bottoms fractions from distillation of crude oils. Due to variations between crude oils, not all vacuum tower bottoms fractions are suitable for production of paving asphalt and/or roofing asphalt.

Another potential source of feedstock for asphalt production is the bottoms or rejection fraction generated by a solvent deasphalting unit. Solvent deasphalting can be used to recover higher value components of a vacuum tower bottoms fraction (and/or other vacuum resid fraction) as a deasphalted oil. The rejection fraction from a solvent deasphalting unit is often referred to as deasphalter rock. Although solvent deasphalting is effective for recovering higher value portions of a vacuum tower bottoms fraction, one difficulty with solvent deasphalting is that the rejected fraction (deasphalter rock) is difficult to incorporate into a refinery product. Due to the nature of deasphalter rock, coking of deasphalter rock results in very poor yields of liquid product. Another option can be to blend deasphalter rock with a higher value flux in order to make an asphalt fraction (optionally after further processing) with commercially viable properties, such as an asphalt fraction suitable for use as a paving asphalt. Unfortunately, due to the challenging nature of the deasphalter rock properties, achieving a desirable paving asphalt typically requires incorporation of 25 wt % or more of deasphalted oil or other heavy vacuum gas oil. It is further noted that attempting to add lighter vacuum gas oil or other distillate fluxes derived from mineral sources in order to achieve desirable properties can also pose difficulties, due the limited compatibility (e.g., solubility) of deasphalter rock with conventional distillate feeds.

It would be desirable to have systems, methods, and/or compositions that can facilitate upgrading of deasphalter rock to paving asphalt while reducing or minimizing the amount of higher value feedstocks that are required to achieve commercial specifications. More generally, it would be desirable to have systems, methods, and/or compositions that can facilitate upgrading the properties of asphalts or asphalt fractions.

U.S. Patent Application Publication 2019/0016965 describes compositions and methods for forming compositions by using a three-product deasphalting method to form a deasphalted oil, a resin, and deasphalter rock from a vacuum resid feed. The outputs from the deasphalting process are then used, in combination with a heavy vacuum gas oil, to form an improved product slate including an asphalt and at least one additional product that can be used as a fuel and/or as an input for production of fuel (such as use as part of a feed to an FCC process). In some examples, the asphalts formed correspond to asphalts with a penetration at 25° C. of 65 dmm or less.

U.S. Patent Application Publication 2020/0131403 describes incorporation of up to 10 wt % corn oil into an asphalt product. The examples describe incorporation of corn oil to form blends of asphalt and corn oil prior to oxidation that include between 1 wt % and 3 wt % corn oil. It is noted that in Example 3, the asphalt mixture that included 0% corn oil was oxidized to form an oxidized asphalt composition with a softening point of 99° C. and a penetration at 25° C. of 12 dmm.

U.S. Patent Application Publication 2017/0096583 and U.S. Pat. No. 9,181,456 describe asphalt compositions based on combinations of bitumen and bio-based material. Some examples included in the '583 publication describe mixtures of bitumen with 10 wt %, 15 wt %, or 20 wt % of recycled cooking oil. Some examples also describe incorporation of soybean oil or a highly esterified sucrose polyester into an asphalt mixture, but those examples use starting asphalts that appears to be of relatively high quality before addition of bio-oil. For example, in the example related to blending with soybean oil, the starting asphalt alone (with no soybean oil) was able to be air blown to form an air blown asphalt composition with a penetration at 25° C. of 19 dmm at a softening point of 94° C. Similarly, in the example related to blending with highly esterified sucrose polyester, the starting asphalt alone (with no blend component) was able to be air blown to form an air blown asphalt composition with a penetration at 25° C. of 17 dmm at a softening point of 100° C.

U.S. Pat. No. 10,604,655 describes an asphalt shingle product that includes semi-epoxidized vegetable oil in the asphalt. Thus, the asphalt includes a significant number of oxidized functional groups.

### SUMMARY

In an aspect, an asphalt composition is provided. The asphalt composition includes a hydrocarbonaceous fraction having a dynamic viscosity at 130° C. of 8.0 P or more and a high temperature performance grade of 58 or higher. The asphalt composition further includes 2.0 wt % to 20 wt % of a bio-oil, based on a combined weight of the hydrocarbonaceous fraction and the bio-oil. The asphalt composition can have a high temperature performance grade of 58 or higher and a low temperature performance grade of −10 or lower.

Optionally, the asphalt composition can include 40 wt % or more, or 70 wt % or more, of the hydrocarbonaceous fraction relative to a total weight of the asphalt composition. Optionally, a carbon intensity of the asphalt composition can be lower than a carbon intensity of the hydrocarbonaceous fraction by possibly 20% or more. Optionally, the asphalt composition can correspond to a paving asphalt.

In another aspect, an asphalt composition is provided. The asphalt composition can include an asphalt fraction having a kinematic viscosity at 100° C. of 1000 cSt or less and a high temperature performance grade of 58 or higher. The asphalt composition can further include 11 wt % to 25 wt % of a bio-oil based on a total weight of the asphalt fraction and the bio-oil. The asphalt composition can include 5.0 wt % or less of an oxidized bio-oil relative to a weight of the asphalt composition. The asphalt composition can have a high temperature performance grade of 52° C. or lower and a penetration at 25° C. of 300 dmm or lower.

Optionally, the bio-oil can include 10 wt % or more of esters relative to a weight of the bio-oil and/or 10 wt % or more of triglycerides relative to a weight of the bio-oil. Optionally, the asphalt fraction can correspond to a paving asphalt (such as a paving asphalt formed from deasphalter rock and additional bio-oil) and the asphalt composition can correspond to a roofing asphalt. Optionally, the asphalt composition can be oxidized to form an oxidized asphalt composition having a penetration at 25° C. of 12 dmm or more and/or a softening point of 99° C. or higher and/or a high temperature performance grade of 82 or higher.

### BRIEF DESCRIPTION OF THE DRAWINGS

FIG. 1 shows a performance grade plot for blends of deasphalter rock and bio-oil.

FIG. 2 shows properties of asphalt compositions formed from deasphalted rock and bio-oil.

FIG. 3 shows oxidation curves for various asphalt blends.

FIG. 4 shows properties of deasphalted rock fractions generated by a high lift solvent deasphalting process.

FIG. 5 shows an oxidation curve for an additional asphalt blend.

### DETAILED DESCRIPTION

All numerical values within the detailed description and the claims herein are modified by “about” or “approximately” the indicated value, and take into account experimental error and variations that would be expected by a person having ordinary skill in the art.

In various aspects, asphalt compositions are provided that allow for upgrading of deasphalter rock to asphalt with a performance grade suitable for use as paving asphalt by addition of bio-oil to the deasphalter rock. Using bio-oil instead of a mineral flux to upgrade deasphalter rock can allow the mineral flux to be used for production of higher value products, such as fuels, while also reducing or minimizing the amount of processing required to incorporate the bio-oil into a product. Additionally, in some aspects, the upgrading of the deasphalter rock can be achieved by adding an unexpectedly reduced or minimized amount of a bio-oil to the deasphalter rock. In such aspects, the deasphalter rock can optionally correspond to deasphalter rock formed from a high lift deasphalting process. In contrast to fluxes derived from mineral source, less than 20 wt % bio-oil can be sufficient to upgrade deasphalter rock to asphalt with desirable properties for use as a paving asphalt. Methods of forming asphalt compositions from deasphalter rock and bio-oil are also provided.

In various additional aspects, asphalt compositions are provided that allow for upgrading of paving asphalt (e.g., asphalt with a performance grade corresponding to a paving asphalt) to a roofing asphalt by addition of more than 10 wt % of a bio-oil containing a reduced or minimized amount of compounds containing oxidized functional groups. The bio-oil can be added to the asphalt prior to air blowing. Examples of oxidized functional groups in a bio-oil include ketones, aldehydes, epoxides, and peroxides. These functional groups correspond to functional groups in a bio-oil that are formed from oxidation of another functional group, such as an ether, ester, or olefin. In this discussion, oxidized functional groups are explicitly defined to exclude ethers and esters, as such ester linkages that commonly occur naturally within bio-oils. Prior to oxidation, bio-oils can include a limited amount of such oxidized functional groups, such as including 0.1 wt % to 5.0 wt % of compounds containing oxidized functional groups.

In this discussion, a bio-oil that has been exposed to temperatures of 177° C. or more for a period of 10 minutes or longer is defined as an oxidized bio-oil. By definition, any type of bio-oil used as a cooking oil for cooking at a temperature of 177° C. or higher is considered an oxidized bio-oil. Similarly, any bio-oil formed by a pyrolysis process (i.e, bio containing pyrolysis oils) is by definition an oxidized bio-oil. In some aspects, such as aspects where bio-oil is used to improve a paving asphalt to form a roofing asphalt, an asphalt composition can include 5.0 wt % or less of an oxidized bio-oil, or 3.0 wt % or less, or 1.0 wt % or less.

The number of compounds containing oxidized functional groups in a bio-oil can be increased by a variety of methods in order to form oxidized bio-oils. For example, bio-oils typically include a substantial number of glycerides and/or free fatty acids with olefinic bonds in the carbon chain(s) of the glycerides and/or free fatty acids. These double bonds can be at least partially converted to epoxides by specifically reacting a bio-oil under conditions for forming epoxides. Another way of increasing the number of oxidized functional groups is based on prior use of the bio-oil. For example, using a vegetable oil as a cooking oil corresponds to heating the vegetable oil to temperatures of 177° C. or more in the presence of air (which contains O₂). The resulting used cooking oil can have greater than 5.0 wt % of compounds containing oxidized functional groups. Still another way of increasing the number of compounds containing oxidized functional groups can be based on the method of formation for the bio-oil. For example, pyrolysis oils correspond to bio-oils that are formed by pyrolysis of biomass. Due to the pyrolysis conditions, pyrolysis oils typically contain a substantial portion of compounds containing oxidized functional groups.

Conventionally, asphalt production is constrained by a variety of factors. For example, not all crude oils include an appropriate vacuum tower bottoms fraction to form asphalts. For those crude oils that include appropriate vacuum tower bottoms fractions for asphalt formation, oxidation (e.g., by air blowing) and addition of fluxes are the primary options for modifying the properties of the bottoms fraction to achieve a desired asphalt composition. Addition of fluxes, such as vacuum gas oil flux, is effective for reducing the hardness of an asphalt. This typically results in improvement of low temperature properties while also reducing the high temperature performance grade and the softening point. However, vacuum gas oil fluxes can be used to make substantially higher value products than asphalts. Thus, it is usually desirable to minimize the amount of vacuum gas oil flux that is added to an asphalt product.

Most conventional crudes or crude fractions exhibit similar behavior when oxidized by air blowing in an effort to improve asphalt properties. After an initial modest improvement in high temperature properties with little detriment to low temperature properties, further air blowing of a conventional crude results in a predictable trade-off of improved high temperature properties and decreased low temperature properties. For example, air blowing is effective for increasing the softening point of an asphalt (a high temperature property), but it is at the expense of penetration at 25° C. (an indicator for low temperature properties). Thus, air blowing can only provide improved properties within a constrained window relative to the starting properties of the potential asphalt feedstock.

One impact of the limited options for modifying asphalt properties is in the production of roofing asphalt. It is typically desirable for roofing asphalt to have properties such as a softening point of roughly 100° C. in combination with a penetration at 25° C. of 12 dmm or more. This is an unusual combination of properties for a vacuum resid fraction, so air oxidation is typically used to modify the properties of an asphalt to achieve the desired combination. However, due to the property trade-offs involved in air blowing, achieving a softening point of roughly 100° C. with a penetration at 25° C. of 12 dmm or more typically requires a relatively soft asphalt, such as an asphalt with a high temperature performance grade of 52 or less. This means that the asphalt contains a substantial amount of higher value flux that could be used, for example, for production of lubricants or fuels, but that is instead being incorporated into an asphalt product.

Due to the limited options for processing a feed to improve potential asphalt properties, many of the methods for improving the quality of a potential asphalt fraction are related to addition of higher value feeds or fluxes. As a result, asphalt production is typically a balance between achieving desired asphalt properties while reducing or minimizing loss of yield of other higher value fractions. Asphalt is typically close to being the lowest value product generated from a crude oil that still can yield a net profit (as opposed to being a fraction that incurs a cost for disposal). In particular, deasphalted oil fractions recovered by performing solvent deasphalting on vacuum tower bottoms often have a substantially higher value per volume than asphalt. However, the resulting deasphalter rock has a substantially lower value, due in part to the difficulty in finding a disposition for the deasphalter rock since it is typically not directly usable as an asphalt. U.S. Patent Application Publication 2019/0016965 describes methods for increasing the yields of higher value products from solvent deasphalting while still incorporating all of the deasphalter rock into a commercially viable asphalt product.

It has been discovered that bio-oils can be used as a blending component in unexpectedly low quantities to upgrade deasphalter rock into asphalt with a performance grade that is usable for paving asphalt. Using bio-oil as a flux for upgrading deasphalter rock can provide several advantages. First, the deasphalted oil derived from solvent deasphalting can be fully used for other higher value purposes, such as fuels production. Additionally, the amount of bio-oil added to the deasphalter rock can correspond to 2.0 wt % to 20 wt % of the resulting asphalt fraction, relative to the combined weight of bio-oil and deasphalter rock in the asphalt fraction. This is an unexpectedly low amount of flux for addition to deasphalter rock while still achieving desirable asphalt properties.

Still another potential benefit is that the bio-oil used as a flux for upgrading deasphalter rock can be a raw bio-oil and/or bio-oil that is minimally processed. One of the difficulties with incorporating bio-derived feeds into refinery products is that bio-derived feeds contain a variety of impurities that have reduced compatibility with refinery processes. For example, many types of bio-derived feeds include substantial amounts of nitrogen, oxygen, and metals. Incorporation of such bio-derived feeds into fuel products can require substantial processing to remove these heteroatom impurities. By contrast, such bio-derived feeds can be combined with deasphalter rock to form asphalt fractions without requiring the removal of such impurities.

In addition to upgrading of deasphalter rock to paving asphalt, it has further been discovered that some types of bio-oils can be used to improve the properties of paving asphalt to higher value products such as roofing asphalt. As noted above, due to the trade-offs present in air blowing, there are limited processing options for upgrading the properties of an asphalt fraction without addition of high value fluxes. It has been unexpectedly discovered, however, that bio-oils with a reduced or minimized content of oxidized functional groups, when used in sufficient quantity, can be used to upgrade paving asphalt grades to roofing asphalt grade.

The ester linkages present in glycerides and various other types of bio-oils are examples of oxidizable functional groups, as such linkages correspond to locations where contact with additional oxygen at moderate to high temperatures can result in reaction. For bio-oils such as cooking oils, exposure to cooking temperatures can cause at least a portion of the oxidizable functional groups to be converted to oxidized functional groups. Therefore, addition of such bio-oils to upgrade an asphalt to roofing asphalt can result in a product with an undesirably short lifetime.

By contrast, bio-oils with a reduced or minimized content of oxidized functional groups can provide a low cost flux that be used to upgrade asphalts with a performance grade corresponding to paving asphalt to form an asphalt product with a performance grade corresponding to a roofing asphalt.

### Definitions

Unless otherwise specified, distillation points and boiling points can be determined according to ASTM D2887. For samples that are not susceptible to characterization using ASTM D2887, D7169 can be used. It is noted that still other methods of boiling point characterization may be provided in the examples. The values generated by such other methods are believed to be indicative of the values that would be obtained under ASTM D2887 and/or D7169.

In this discussion, a Txx distillation point refers to the portion “xx” of a fraction can be distilled off at the corresponding temperature. Thus, a T10 distillation point of 370° C. means that 10 wt % of a sample can be distilled off at 370° C.

In this discussion, a vacuum resid fraction is defined as a fraction with a T10 distillation point of 370° C. or higher (such as up to 593° C.) and a T50 distillation point of 565° C. or higher (such as up to 650° C.). It is noted that some vacuum towers may be operated in a manner so that the bottoms fraction from the tower includes a large percentage of 565° C.-material. Such bottoms fractions may fall outside of the scope of this vacuum resid definition. In this discussion, a vacuum gas oil fraction is defined as a fraction with a T10 distillation point of 343° C. or more (such as up to 510° C.) and a T90 distillation point of 565° C. or less (such as down to 510° C.). In this discussion, a heavy vacuum gas oil fraction is defined as a fraction with a T10 distillation point of 450° C. or more (such as up to 510° C.) and a T90 distillation point of 565° C. or less (such as down to 510° C.). A distillate fuel boiling range fraction is defined as a fraction with a T10 distillation point of 170° C. or more (such as up to 300° C.), a final boiling point of 300° C. or more (such as up to 450° C.), and a T90 distillation point of 370° C. or less (such as down to 300° C.). It is noted that the above definitions in this paragraph are based on boiling point only. Thus, for example, a vacuum resid fraction can include components that did not pass through a distillation tower or other separation stage based on boiling point.

In this discussion, a non-hydroprocessed fraction is defined as a fraction that has not been exposed to more than 10 psia of hydrogen in the presence of a catalyst comprising a Group VI metal, a Group VIII metal, a catalyst comprising a zeolitic framework, or a combination thereof. In this discussion, a non-cracked fraction is defined as a fraction that has not been exposed to a temperature of 400° C. or more.

In this discussion, a hydroprocessed fraction refers to a hydrocarbon fraction and/or hydrocarbonaceous fraction that has been exposed to a catalyst having hydroprocessing activity in the presence of 300 kPa-a or more of hydrogen at a temperature of 200° C. or more. Examples of hydroprocessed fractions include hydroprocessed distillate fractions (i.e., a hydroprocessed fraction having the distillate boiling range), hydroprocessed kerosene fractions (i.e., a hydroprocessed fraction having the kerosene boiling range) and hydroprocessed diesel fractions (i.e., a hydroprocessed fraction having the diesel boiling range). It is noted that a hydroprocessed fraction derived from a biological source, such as hydrotreated vegetable oil, can correspond to a hydroprocessed distillate fraction, a hydroprocessed kerosene fraction, and/or a hydroprocessed diesel fraction, depending on the boiling range of the hydroprocessed fraction. A hydroprocessed fraction can be hydroprocessed prior to separation of the fraction from a crude oil or another wider boiling range fraction.

With regard to characterizing properties of resid boiling range fractions and/or blends of such fractions with other components, a variety of methods can be used. Density of a blend at 15° C. (kg/m³) can be determined according ASTM D4052. Sulfur (in wppm or wt %) can be determined according to ASTM D2622, while nitrogen (in wppm or wt %) can be determined according to D4629. Kinematic viscosity at 50° C., 70° C., and/or 100° C. can be determined according to ASTM D445. Micro Carbon Residue (MCR) content can be determined according to ASTM D4530. The content of n-heptane insolubles can be determined according to ASTM D3279.

### Bio-Oil Feedstocks

In some aspects, deasphalter rock can be blended with one or more bio-oil feeds to form an asphalt composition. The amount of bio-oil in the blend can correspond to 2.0 wt % to 20 wt % of the combined weight of deasphalter rock and bio-oil. Optionally, one or more additional mineral feeds can also be included in the asphalt composition. The one or more additional mineral feeds can preferably correspond to 10 wt % or less of the asphalt composition.

In other aspects, a paving grade asphalt can be blended with one or more bio-oil feeds to form a roofing grade asphalt composition. The amount of bio-oil in the blend can correspond to 11 wt % to 25 wt % of the combined weight of paving grade asphalt and bio-oil. Optionally, one or more additional mineral feeds can also be included in the roofing grade asphalt composition. The one or more additional mineral feeds can preferably correspond to 10 wt % or less of the roofing grade asphalt composition. In some aspects, such as aspects related to upgrading a paving grade asphalt to a roofing grade asphalt composition, the bio-oil can correspond to a feed containing a reduced or minimized amount of oxidized functional groups.

A bio-oil can correspond to a feed derived from a biological source. The feedstock can include fatty acids or fatty acid derivatives. Fatty acid derivatives can include, but are not limited to, fatty acid alkyl esters, such as fatty acid methyl esters (FAME); mono-, di-, and triglycerides; and other fatty acid derivatives that includes carbon chain length of 10 atoms to 20 atoms. In this discussion, a fatty acid carbon chain is defined as a carbon chain having 10-22 carbon atoms that is terminated at one end by either a carboxylic acid group or an ester linkage to another carbon chain (such as the propyl backbone of a triglyceride). A compound can include multiple fatty acid carbon chains. For example, a triglyceride contains three fatty acid carbon chains.

In this discussion, a feed derived from a biological source refers to a feedstock derived from a biological raw material component, such as vegetable fats/oils or animal fats/oils, fish oils, select pyrolysis oils, and algae lipids/oils, as well as components of such materials, and in some embodiments can specifically include one or more types of lipid compounds. Lipid compounds are typically biological compounds that are insoluble in water, but soluble in nonpolar (or fat) solvents. Non-limiting examples of such solvents include alcohols, ethers, chloroform, alkyl acetates, benzene, and combinations thereof.

Examples of vegetable oils that can be used in accordance with this invention include, but are not limited to rapeseed (canola) oil, soybean oil, coconut oil, sunflower oil, palm oil, palm kernel oil, peanut oil, linseed oil, tall oil, corn oil, castor oil, jatropha oil, jojoba oil, olive oil, flaxseed oil, camelina oil, safflower oil, babassu oil, tallow oil and rice bran oil.

In some aspects, the vegetable oil can correspond to an oil derived as a by-product during processing of biomass for another purpose. For example, during production of ethanol from corn biomass, a corn oil by-product is generated.

Algae oils or lipids can typically be contained in algae in the form of membrane components, storage products, and/or metabolites. Certain algal strains, particularly microalgae such as diatoms and cyanobacteria, can contain proportionally high levels of lipids. Algal sources for the algae oils can contain varying amounts, e.g., from 2 wt % to 40 wt % of lipids, based on total weight of the biomass itself.

Vegetable fats/oils, animal fats/oils, fish oils, pyrolysis oils, and/or algae lipids/oils as referred to herein can also include processed material. Non-limiting examples of processed vegetable, animal (including fish), and algae material include fatty acids and fatty acid alkyl esters. Alkyl esters typically include C₁-C₅ alkyl esters of fatty acids. One or more of methyl, ethyl, and propyl esters are preferred.

Other biocomponent feeds usable in the present invention can include any of those which comprise primarily triglycerides and free fatty acids (FFAs). The triglycerides and FFAs typically contain aliphatic hydrocarbon chains in their structure having from 8 to 36 carbons, preferably from 10 to 26 carbons, for example from 10 to 22 carbons or 14 to 22 carbons. Types of triglycerides can be determined according to their fatty acid constituents. The fatty acid constituents can be readily determined using Gas Chromatography (GC) analysis. This analysis involves extracting the fat or oil, saponifying (hydrolyzing) the fat or oil, preparing an alkyl (e.g., methyl) ester of the saponified fat or oil, and determining the type of (methyl) ester using GC analysis. In one embodiment, a majority (i.e., greater than 50%) of the triglyceride present in the lipid material can be comprised of C₁₀ to C₂₆ fatty acid constituents, based on total triglyceride present in the lipid material. Further, a triglyceride is a molecule having a structure corresponding to a reaction product of glycerol and three fatty acids. Although a triglyceride is described herein as having side chains corresponding to fatty acids, it should be understood that the fatty acid component does not necessarily contain a carboxylic acid hydrogen. Other types of feed that are derived from biological raw material components can include fatty acid esters, such as fatty acid alkyl esters (e.g., FAME and/or FAEE).

In some aspects, the feedstock can include 10 wt % or more of triglycerides, or 25 wt % or more, or 40 wt % or more, or 60 wt % or more, such as up to being substantially composed of triglycerides (i.e., up to 100 wt %, or including less than 1.0 wt % of other compounds). In some aspects, the feedstock can include 10 wt % or more of fatty acid alkyl esters, or 25 wt % or more, or 40 wt % or more, or 60 wt % or more, such as up to being substantially composed of fatty acid alkyl esters (i.e., up to 100 wt %, or including less than 1.0 wt % of other compounds). In some aspects, the feedstock can include a combined weight of triglycerides and fatty acid alkyl esters of 10 wt % or more, or 25 wt % or more, or 40 wt % or more, or 60 wt % or more, such as up to being substantially composed of fatty acid alkyl esters and triglycerides (i.e., up to 100 wt %, or including less than 1.0 wt % of other compounds).

A feed derived from a biological source can have a wide range of nitrogen and/or sulfur contents. For example, a feedstock based on a vegetable oil source can contain up to 300 wppm nitrogen. In contrast, a biomass based feedstream containing whole or ruptured algae can sometimes include a higher nitrogen content. Depending on the type of algae, the nitrogen content of an algae based feedstream can be at least 2 wt %, for example at least 3 wt %, at least 5 wt %, such as up to 10 wt % or possibly still higher. The sulfur content of a feed derived from a biological source can also vary. In some embodiments, the sulfur content can be 500 wppm or less, for example 100 wppm or less, or 50 wppm or less, such as down to being substantially free of sulfur (1.0 wppm or less).

Aside from nitrogen and sulfur, oxygen can be another heteroatom component in feeds derived from a biological source. For example, a feed derived from a biological source, prior to hydrotreatment, can include 1.0 wt % to 15 wt % of oxygen, or 1.0 wt % to 10 wt %, or 3.0 wt % to 15 wt %, or 3.0 wt % to 10 wt %, or 4.0 wt % to 15 wt %, or 4.0 wt % to 12 wt %.

### Life Cycle Assessment and Carbon Intensity

In some aspects, yet another advantage of incorporating a bio-oil into an asphalt composition is that the carbon intensity of the asphalt can be possibly reduced or minimized. A portion of the carbon intensity benefit can be possibly based on the fact that asphalt is typically used as a structural material. When bio-oil is incorporated into asphalt, CO₂ is removed from the air as the biomass is formed, and then the resulting bio-oil derived from the biomass is used in a material (asphalt) that remains in a solid form. Therefore, any bio-oil incorporated into an asphalt composition corresponds to CO₂ that is removed from atmosphere. This means that incorporation of bio-oil into asphalt compositions could potentially even result in a negative value for total carbon intensity, based on the incorporation of CO₂ from the atmosphere into a structural material. The reduction in “cradle-to-gate” carbon intensity by using bio-oil in an asphalt composition can be possibly on the order of 10% to 100% of the total carbon intensity for the asphalt, or 20% to 100%, or 40% to 100%, or 10% to 50%, or 20% to 50%. For example, the “cradle-to-gate” carbon intensity of an asphalt composition can be potentially lower than the carbon intensity of the mineral portion of the asphalt composition by at least 10%, or at least 15%, or at least 20%, or at least 30%, or at least 40%. The potential reduction in the “cradle-to-gate” carbon intensity of an asphalt composition may vary depending on factors such as (1) the blend level of bio-oil as a percentage of the asphalt composition, and (2) the carbon intensity reduction of the bio-oil components blended in the asphalt composition. This is an unexpected benefit, given the difficulty in achieving even small improvements in carbon intensity for conventional products made from mineral petroleum sources. The unexpectedly large nature of the benefit is due to the fact that the bio-oils can potentially have a negative “cradle-to-gate” carbon intensity, due to the carbon dioxide extracted from the atmosphere during growth of the biomass and stored in the bio-oils as carbon. The amount of stored biogenic carbon are equivalent to 2.8 kg CO₂/kg bio-oil based on the carbon content of the bio-oil.

Other advantages can be advantages relative to other uses of bio-oil as a replacement for hydrocarbons. For example, bio-oils can be used as a possible replacement for hydrocarbons in some fuel product applications or fuel product blends. However, due to the oxygen content (and/or nitrogen content and/or metals content) in some bio-oils, incorporation of bio-oils into fuels often requires additional processing of the bio-oils, such as hydroprocessing and/or other energy intensive processes. By contrast, bio-oils may be incorporated into some asphalt fractions without any further processing. Optionally, for some types of asphalt compositions, air blowing can be performed after bio-oil addition to modify the performance characteristics of the asphalt composition. By reducing, minimizing, or avoiding the amount of hydroprocessing and/or other refinery processing needed to use bio-oil as a substitute for a mineral petroleum feed, the net amount of CO₂ generation that is required to use the bio-oil as a replacement for mineral hydrocarbons can be possibly further reduced.

The lower carbon intensity of an asphalt composition containing at least a portion of a bio-oil as described herein can be possibly realized by using an asphalt composition containing at least a portion of such a bio-oil in any convenient type of asphalt application. This can include, but is not limited to, paving asphalt, roofing asphalt, and/or other conventional uses for asphalt compositions.

Life cycle assessment (LCA) is a method of quantifying the “comprehensive” environmental impacts of manufactured products, including asphalt products. Among various environmental impacts, this discussion specifically considered greenhouse gas (GHG) emissions associated with the finished product, namely carbon intensity. However, because asphalt products are structural products and not combusted during the intended structural application, the analysis herein focuses on the GHG emissions benefits for the intended structural application. Moreover, any GHG emissions during end use (e.g., loss of gaseous material from a roofing shingle after installation or from a paved road surface, incremental emissions from vehicle operation [due to surface roughness and deflection], lighting, heat island, etc.) and end-of-life (e.g., removal, milling, landfilling, and recycling) are excluded here. The exclusion of these end use and end-of-life stages is justified by the fact that there is no evidence to suggest that there would be any negative GHG emissions impact from bio-oil composition during end use and end-of-life. With the expected similarity in product quality between asphalt products with and without bio-oil, no significant difference in GHG emissions from these end use and end-of-life stages is expected. Moreover, the majority of the GHG emissions during these stages are incremental GHG emissions from vehicle operation due to surface roughness and deflection, which depend on factors like climate, traffic conditions, vehicles' nominal fuel economy, etc. These factors have high variability adding significant uncertainty to the life-cycle GHG emissions estimates and are irrelevant to the scope of this invention. In this discussion, therefore, the life cycle assessment is provided from “cradle to gate”. The general guidelines for carbon footprint quantification are specified in ISO 14067.

In this discussion, the “carbon intensity” of an asphalt composition is defined as the cradle-to-gate GHG emissions associated with that product (kg CO₂ eq) per kilogram of asphalt. Cradle-to-gate GHG emissions associated with asphalt products as described herein include GHG emissions associated with crude oil and/or bio-oil production (including activities such as seed farming for bio-oil); crude oil and/or bio-oil transportation to a refinery (and/or a mill in the case of bio-oil); refining/processing of the crude oil and/or bio-oil; transport of the refined/processed crude oil and/or bio-oil to the terminal; and final blending of asphalt/asphalt binders at the terminal to form the desired asphalt product. It is noted that for bio-oils such as soybean oil that are the primary product formed from the biomass, GHG emissions associated with land use change are also included.

GHG emissions associated with the selected stages of refined product life cycles are assessed as follows.

(1) GHG emissions associated with drilling and well completion—including hydraulic fracturing, shall be normalized with respect to the expected ultimate recovery of sales-quality crude oil from the well.

(2) All GHG emissions associated with the production of oil and associated gas, including those associated with (a) operation of artificial lift devices, (b) separation of oil, gas, and water, (c) crude oil stabilization and/or upgrading, among other GHG emissions sources shall be normalized with respect to the volume of oil transferred to sales (e.g. to crude oil pipelines or rail). The fractions of GHG emissions associated with production equipment to be allocated to crude oil, natural gas, and other hydrocarbon products (e.g. natural gas liquids) shall be specified accordance with ISO 14067.

(3) GHG emissions associated with rail, pipeline or other forms of transportation between the production site(s) to the refinery shall be normalized with respect to the volume of crude oil transferred to the refinery.

(4) GHG emissions associated with the refining of crude oil to make liquefied petroleum gas, gasoline, distillate fuels and other products shall be assessed, explicitly accounting for the material flows within the refinery. These emissions shall be normalized with respect to the volume of crude oil refined.

(5) All of the preceding GHG emissions shall be summed to obtain the “Well to refinery” (WTR) GHG intensity of crude oil (e.g. kg CO₂ eq/bbl crude).

(6) For each refined product, the WTR GHG emissions shall be divided by the product yield (barrels of refined product/barrels of crude), and then multiplied by the share of refinery GHG specific to that refined product. The allocation procedure shall be conducted in accordance with ISO 14067. This procedure yields the WTR GHG intensity of each refined product (e.g. kg CO₂ eq/kg asphalt or kg CO₂ eq/barrel asphalt). Because the carbon intensity values provided herein are “cradle to gate” value, the WTR GHG intensity for asphalt is the carbon intensity.

(7) For bio-oil incorporated into an asphalt product, a process similar to steps (1) to (6) is followed. It is noted that for bio-oil, some parts of the GHG emissions calculation may have negative values. For example, the growth of biomass consumes CO₂ from the air. Therefore, even though some GHG emissions may be incurred during planting, maintaining, and harvesting of biomass, the net GHG emissions associated with production of biomass may be possibly negative. It is further noted that since the GHG emissions are being calculated “cradle to gate”, the overall GHG emissions for the portion of bio-oil incorporated into the asphalt may be possibly negative, as the CO₂ withdrawn from the atmosphere by the biomass may be possibly larger than the GHG emissions associated with production and incorporation of the biomass into the asphalt.

(8) For bio-oil that is derived as a secondary by-product from a primary process, the GHG emissions for the primary process are assigned to the primary process, rather than being apportioned between the primary process and the secondary by-product. For example, during ethanol production from corn biomass, the GHG emissions associated with ethanol production are assigned to the ethanol as the primary product, and only the incremental GHG emissions associated with corn oil extraction and refining are assigned to the corn oil.

### Performance Grade Characterization

One way of characterizing an asphalt composition is by using SUPERPAVE™ criteria. SUPERPAVE™ criteria (as described in the June 1996 edition of the AASHTO Provisional Standards Book and 2003 revised version) can be used to define the Maximum and Minimum Pavement service temperature conditions under which the binder must perform. SUPERPAVE™ is a trademark of the Strategic Highway Research Program (SHRP) and is the term used for new binder specifications as per AASHTO MP-1 standard. Maximum Pavement Temperature (or “application” or “service” temperature) is the temperature at which the asphalt binder will resist rutting (also called Rutting Temperature). Minimum Pavement Temperature is the temperature at which the binder will resist cracking. Low temperature properties of asphalt binders were measured by Bending Beam Rheometer (BBR). According to SUPERPAVE™ criteria, the temperature at which a maximum creep stiffness (S) of 300 MPa at 60 s loading time is reached, is the Limiting Stiffness Temperature (LST). Minimum Pavement Temperature at which the binder will resist cracking (also called Cracking Temperature) is equal to LST−10° C.

The SUPERPAVE™ binder specifications for asphalt paving binder performance establishes the high temperature and low temperature stiffness properties of an asphalt. The nomenclature is PG XX-YY which stands for Performance Grade at high temperatures (HT), XX, and at low temperatures (LT), −YY degrees C., wherein —YY means a temperature of minus YY degrees C. Asphalt must resist high summer temperature deformation at temperatures of XX degrees C. and low winter temperature cracking at temperatures of −YY degrees C. An example popular grade in Canada is PG 58-28. Each grade of higher or lower temperature differs by 6° C. in both HT and LT. This was established because the stiffness of asphalt doubles about every 6° C. One can plot the performance of asphalt on a SUPERPAVE™ matrix grid. The vertical axis represents increasing high PG temperature stiffness and the horizontal axis represents decreasing low temperature stiffness towards the left.

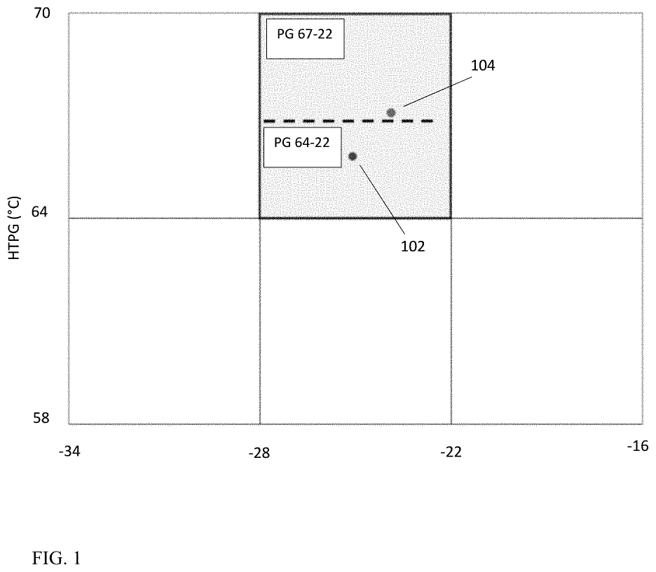

The data in FIG. 1 is an example of data plotted on a SUPERPAVE™ PG matrix grid. Directionally poorer asphalt performance is to the lower right. Target exceptional asphalt or enhanced, modified asphalt performance is to the upper left, most preferably in both the HT and LT performance directions.

Although asphalt falls within a PG box that allows it to be considered as meeting a given PG grade, the asphalt may not be robust enough in terms of statistical quality control to guarantee the PG quality due to variation in the PG tests. This type of property variation is recognized by the asphalt industry as being as high at approximately +/−3° C. Thus, if an asphalt producer wants to consistently manufacture a given grade of asphalt, such PG 64-28, the asphalt producer must ensure that the PG tests well within the box and not in the right lower corner of the box.

### Deasphalter Rock

Due to the nature of how deasphalter rock is formed, in various aspects deasphalter rock can have a relatively stiff high temperature performance grade of 58 or higher. Unfortunately, deasphalter rock also tends to be brittle, with relatively low penetration values at 25° C. and/or relatively poor low temperature performance grade values. In order to overcome these difficulties, a deasphalter rock needs to be combined with a flux that can improve the low temperature properties (such as penetration at 25° C.) while maintaining desirable high temperature properties (such as softening point). Additionally, it is desirable to use as little of a flux as possible to achieve this improvement in properties, as conventional fluxes added to deasphalter rock typically correspond to feedstocks that could be incorporated into other higher value products.

In this discussion, deasphalter rock is defined as a hydrocarbonaceous fraction that has a dynamic viscosity at 135° C. of 8.0 P (800 cP) or higher. For purposes of this definition, a hydrocarbonaceous fraction is defined as a fraction that primarily contains hydrocarbons (based on only carbon and hydrogen), but may also contain compounds that include heteroatoms such as sulfur, nitrogen, oxygen, and/or trace metals. Additionally or alternately, the deasphalter rock can have a high temperature performance grade, prior to addition of bio-oil, of 58 or higher. Although rare, it is noted that a vacuum resid fraction formed with a sufficiently high distillation temperature could result in properties similar to deasphalter rock. In other words, a vacuum resid fraction with a sufficiently high dynamic viscosity at 135° C. would pose problems similar to deasphalter rock with regard to upgrading the vacuum resid fraction to a desirable asphalt composition. Such vacuum resid fractions can also be upgraded by addition of bio-oil.

Deasphalter rock can be formed by exposing a vacuum resid feed (or a feedstock containing a vacuum resid portion) to solvent deasphalting conditions. Solvent deasphalting is a solvent extraction process. In some aspects, suitable solvents for methods as described herein include alkanes or other hydrocarbons (such as alkenes) containing 4 to 7 carbons per molecule. In other aspects, suitable solvents can include 3 to 7 carbons per molecule. Examples of suitable solvents include n-butane, isobutane, n-pentane, C₄₊ alkanes, C₅₊ alkanes, C₄₊ hydrocarbons, and C₅₊ hydrocarbons. In other aspects, suitable solvents can include C₃ hydrocarbons, such as propane. In such other aspects, examples of suitable solvents include propane, n-butane, isobutane, n-pentane, C₃₊ alkanes, C₄₊ alkanes, C₅₊ alkanes, C₃₊ hydrocarbons, C₄₊ hydrocarbons, and C₅₊ hydrocarbons.

In this discussion, a solvent comprising Cₙ (hydrocarbons) is defined as a solvent composed of at least 80 wt % of alkanes (hydrocarbons) having n carbon atoms, or at least 85 wt %, or at least 90 wt %, or at least 95 wt %, or at least 98 wt %. Similarly, a solvent comprising Cₙ₊ (hydrocarbons) is defined as a solvent composed of at least 80 wt % of alkanes (hydrocarbons) having n or more carbon atoms, or at least 85 wt %, or at least 90 wt %, or at least 95 wt %, or at least 98 wt %.

In this discussion, a solvent comprising Cₙ alkanes (hydrocarbons) is defined to include the situation where the solvent corresponds to a single alkane (hydrocarbon) containing n carbon atoms (for example, n=3, 4, 5, 6, 7) as well as the situations where the solvent is composed of a mixture of alkanes (hydrocarbons) containing n carbon atoms. Similarly, a solvent comprising Cₙ₊ alkanes (hydrocarbons) is defined to include the situation where the solvent corresponds to a single alkane (hydrocarbon) containing n or more carbon atoms (for example, n=3, 4, 5, 6, 7) as well as the situations where the solvent corresponds to a mixture of alkanes (hydrocarbons) containing n or more carbon atoms. Thus, a solvent comprising C₄₊ alkanes can correspond to a solvent including n-butane; a solvent include n-butane and isobutane; a solvent corresponding to a mixture of one or more butane isomers and one or more pentane isomers; or any other convenient combination of alkanes containing 4 or more carbon atoms. Similarly, a solvent comprising C₅₊ alkanes (hydrocarbons) is defined to include a solvent corresponding to a single alkane (hydrocarbon) or a solvent corresponding to a mixture of alkanes (hydrocarbons) that contain 5 or more carbon atoms. Alternatively, other types of solvents may also be suitable, such as supercritical fluids. In various aspects, the solvent for solvent deasphalting can consist essentially of hydrocarbons, so that at least 98 wt % or at least 99 wt % of the solvent corresponds to compounds containing only carbon and hydrogen. In aspects where the deasphalting solvent corresponds to a C₄₊ deasphalting solvent, the C₄₊ deasphalting solvent can include less than 15 wt % propane and/or other C₃ hydrocarbons, or less than 10 wt %, or less than 5 wt %, or the C₄₊ deasphalting solvent can be substantially free of propane and/or other C₃ hydrocarbons (less than 1 wt %). In aspects where the deasphalting solvent corresponds to a C₅₊ deasphalting solvent, the C₅₊ deasphalting solvent can include less than 15 wt % propane, butane and/or other C₃-C₄ hydrocarbons, or less than 10 wt %, or less than 5 wt %, or the C₅₊ deasphalting solvent can be substantially free of propane, butane, and/or other C₃-C₄ hydrocarbons (less than 1 wt %). In aspects where the deasphalting solvent corresponds to a C₃₊ deasphalting solvent, the C₃₊ deasphalting solvent can include less than 10 wt % ethane and/or other C₂ hydrocarbons, or less than 5 wt %, or the C₃₊ deasphalting solvent can be substantially free of ethane and/or other C₂ hydrocarbons (less than 1 wt %).

Deasphalting of heavy hydrocarbons, such as vacuum resids, is known in the art and practiced commercially. A deasphalting process typically corresponds to contacting a heavy hydrocarbon with an alkane solvent (propane, butane, pentane, hexane, heptane etc and their isomers), either in pure form or as mixtures, to produce two types of product streams. One type of product stream can be a deasphalted oil extracted by the alkane, which is further separated to produce deasphalted oil stream. A second type of product stream can be a residual portion of the feed not soluble in the solvent, often referred to as rock or asphaltene fraction. The deasphalted oil fraction can be further processed into make fuels or lubricants. The rock fraction can be further used as blend component to produce asphalt, fuel oil, and/or other products. The rock fraction can also be used as feed to gasification processes such as partial oxidation, fluid bed combustion or coking processes. The rock can be delivered to these processes as a liquid (with or without additional components) or solid (either as pellets or lumps).

During solvent deasphalting, a resid boiling range feed (optionally also including a portion of a vacuum gas oil feed) can be mixed with a solvent. Portions of the feed that are soluble in the solvent are then extracted, leaving behind a residue with little or no solubility in the solvent. The portion of the deasphalted feedstock that is extracted with the solvent is often referred to as deasphalted oil. Typical solvent deasphalting conditions include mixing a feedstock fraction with a solvent in a weight ratio of from about 1:2 to about 1:10, such as about 1:8 or less. Typical solvent deasphalting temperatures range from 40° C. to 200° C., or 40° C. to 150° C., depending on the nature of the feed and the solvent. The pressure during solvent deasphalting can be from about 50 psig (345 kPag) to about 500 psig (3447 kPag).

It is noted that the above solvent deasphalting conditions represent a general range, and the conditions will vary depending on the feed. For example, under typical deasphalting conditions, increasing the temperature can tend to reduce the yield while increasing the quality of the resulting deasphalted oil. Under typical deasphalting conditions, increasing the molecular weight of the solvent can tend to increase the yield while reducing the quality of the resulting deasphalted oil, as additional compounds within a resid fraction may be soluble in a solvent composed of higher molecular weight hydrocarbons. Under typical deasphalting conditions, increasing the amount of solvent can tend to increase the yield of the resulting deasphalted oil. As understood by those of skill in the art, the conditions for a particular feed can be selected based on the resulting yield of deasphalted oil from solvent deasphalting. In aspects where a C₃ deasphalting solvent is used, the yield from solvent deasphalting can be 40 wt % or less, such as down to 25 wt %. In some aspects, C₄ deasphalting can be performed with a yield of deasphalted oil of 50 wt % or less, or 40 wt % or less, such as down to 35 wt % or even 30 wt %. In various aspects, the yield of deasphalted oil from solvent deasphalting with a C₄₊ solvent can be at least 50 wt % relative to the weight of the feed to deasphalting, or at least 55 wt %, or at least 60 wt % or at least 65 wt %, or at least 70 wt %, such as up to 85 wt %. In aspects where the feed to deasphalting includes a vacuum gas oil portion, the yield from solvent deasphalting can be characterized based on a yield by weight of a 950° F.+ (510° C.) portion of the deasphalted oil relative to the weight of a 510° C.+ portion of the feed. In such aspects where a C₄₊ solvent is used, the yield of 510° C.+ deasphalted oil from solvent deasphalting can be at least 40 wt % relative to the weight of the 510° C.+ portion of the feed to deasphalting, or at least 50 wt %, or at least 55 wt %, or at least 60 wt % or at least 65 wt %, or at least 70 wt %, such as up to 85 wt %. In such aspects where a C₄₋ solvent is used, the yield of 510° C.+ deasphalted oil from solvent deasphalting can be 50 wt % or less relative to the weight of the 510° C.+ portion of the feed to deasphalting, or 40 wt % or less, or 35 wt % or less, such as down to 25 wt %.

As defined herein, deasphalter rock has a dynamic viscosity at 130° C. of 800 cP or higher, such as up to 10,000 cP or possibly still higher. In addition to dynamic viscosity, deasphalter rock can be characterized in various other ways. For example, deasphalter rock can have a high temperature performance grade of 58 or higher, or 70 or higher, or 76 or higher; a density at 15° C. of 1.10 g/cm³ to 1.25 g/cm³; a low temperature performance grade of −10 or higher, or −4 or higher; an n-heptane insolubles content of 25 wt % to 75 wt %; a hydrogen content of 6.5 wt % to 8.4 wt %; and/or a Conradson Carbon content of 40 wt % to 75 wt %. Additionally or alternately, the deasphalter rock can have a penetration at 25° C. of 10 dmm or less.

In some aspects, the deasphalter rock can correspond to a “high lift” deasphalter rock that is formed by a solvent deasphalting process where 40 wt % or more of the 510° C.+ components in the feed are recovered as deasphalted oil. The high lift deasphalter rock can have various properties that are in contrast to the properties of typical (low lift) deasphalter rock fractions. These unusual properties can include the viscosity and/or the density of the deasphalter rock.

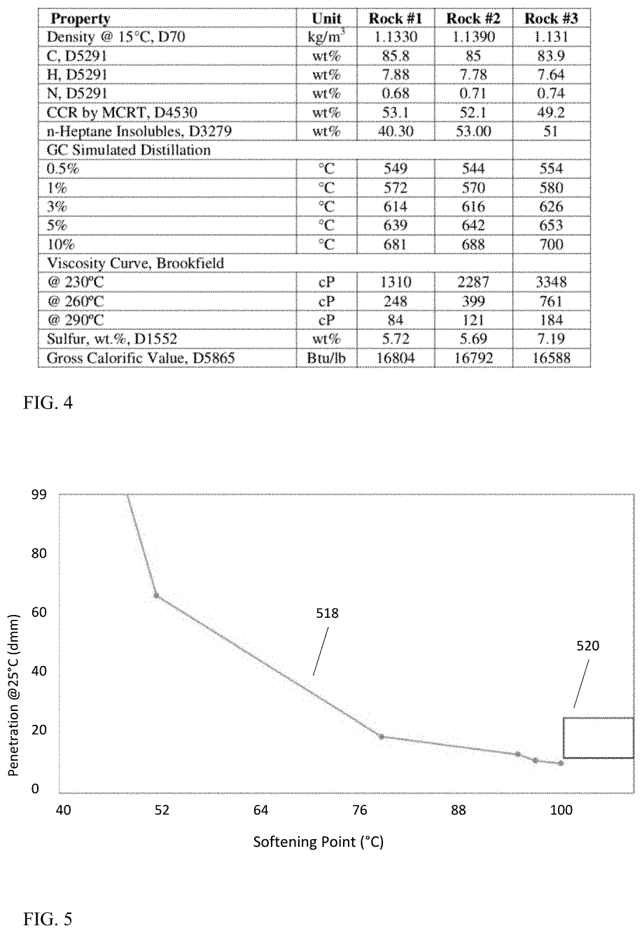

FIG. 4 shows examples of the properties of two types of deasphalter rock formed by solvent deasphalting a resid feed to generate a 75 wt % yield of deasphalted oil. The deasphalting solvent used for generation of both types of rock was n-pentane. FIG. 4 includes test methods used for many of the properties.

As shown in FIG. 4, high lift deasphalter rock can have an unexpectedly high density, such as a density at 15° C. of at least 1.12 g/cm³, or at least 1.13 g/cm³, such as up to 1.25 g/cm³. The Conradson Carbon content can also be high, such as at least 50 wt %, or at least 52 wt %. Additionally, the high lift rock can have a higher viscosity than typical deasphalter rock, such as a Brookfield viscosity at 260° C. of at least 220 cP, or at least 240 cP, or at least 300 cP, such as up to 1000 cP; or a Brookfield viscosity at 290° C. of at least 70 cP, or at least 80 cP, or at least 100 cP, such as up to 800 cP. The boiling range profile can also be elevated, with a T5 distillation point of at least 625° C., or at least 635° C. (such as up to 680° C.); and/or a T10 distillation point of at least 680° C. (such as up to 700° C.). The n-heptane insolubles content of the rock can be at least about 35 wt %, or at least about 40 wt %, or at least about 50 wt %, as measured by ASTM D3279 (fluxed rock fractions can be determined by ASTM D6560, which is believed to be equivalent to IP 143). The hydrogen content can be 8.0 wt % or less, or 7.9 wt % or less, or 7.8 wt % or less. The carbon content can be at least 82.8 wt %, or at least 83.0 wt %, or at least 84.0 wt %, or at least 85.0 wt %, such as up to 92 wt %.

Blending Bio-Oil with Deasphalter Rock

In various aspects, deasphalter rock can be combined with bio-oil to form an asphalt composition that includes 2.0 wt % to 20 wt % bio-oil relative to the combined weight of deasphalter rock and bio-oil in the asphalt composition, or 5.0 wt % to 20 wt % or 2.0 wt % to 15 wt %, or 5.0 wt % to 15 wt %, or 2.0 wt % to 10 wt %. In various aspects, an asphalt composition can include 40 wt % or more of deasphalter rock, relative to the total weight of the asphalt composition, or 50 wt % or more of deasphalter rock, or 60 wt % or more, or 70 wt % or more, such as up to 98 wt %.

In some aspects where the deasphalter rock is formed by propane deasphalting, the asphalt composition can include 2.0 wt % to 15 wt % bio-oil relative to the combined weight of deasphalter rock and bio-oil in the asphalt composition, or 2.0 wt % to 10 wt %.

In some aspects, in addition to deasphalter rock and bio-oil, an asphalt composition can further include one or more additional feeds or fluxes. One example of a feed that can be added to the asphalt composition is a vacuum resid fraction that contains a) 10 wt % or more of n-heptane asphaltenes and/or b) 20 wt % or more of micro carbon residue. Vacuum resid fractions are conventional asphalt feedstocks. While such vacuum resid feeds are typically compatible with deasphalter rock for solubility, a vacuum resid feed has limited ability to offset the poor properties of deasphalter rock. In various aspects, an asphalt composition can include 55 wt % or less of a vacuum resid feed, relative to a total weight of the asphalt composition, or 50 wt % or less, or 40 wt % or less, or 25 wt % or less, such as down to 1.0 wt %. In other aspects, an asphalt composition can include substantially no additional vacuum resid feeds (less than 1.0 wt %).

In some aspects, in addition to deasphalter rock and bio-oil (and optionally one or more vacuum resid fractions), an asphalt composition can further include a minor portion of a mineral feedstock, such as a vacuum gas oil fraction and/or a deasphalted oil fraction. In such aspects, the amount of vacuum gas oil and/or deasphalted oil in the asphalt composition can preferably be less than the amount of bio-oil in the asphalt composition. Some deasphalted oils can correspond to vacuum gas oil fractions. Other deasphalted oils can correspond to vacuum resid fractions that have low content of asphaltenes and/or micro carbon residue, such as less than 10 wt % n-heptane asphaltenes and/or less than 20 wt % micro carbon residue. 10 wt % or less of a mineral feedstock, or 5.0 wt % or less, or 2.0 wt % or less, such as down to 0.05 wt % or possibly still lower. More generally, a mineral feedstock refers to a conventional feedstock, typically derived from crude oil and that has optionally been subjected to one or more separation and/or other refining processes. In one preferred embodiment, the mineral feedstock can be a petroleum feedstock boiling in the distillate fuel range or above. Examples of mineral feedstocks can include, but are not limited to, virgin distillates, hydrotreated virgin distillates, diesel boiling range feeds (such as hydrotreated diesel boiling range feeds), light cycle oils, atmospheric gasoils, and the like, and combinations thereof. In some aspects, an asphalt composition can include 10 wt % or less of a vacuum gas oil fraction, a deasphalted oil fraction, or another mineral feedstock, or 5.0 wt % or less, such as down to 1.0 wt %. In other aspects, the asphalt composition can include substantially no additional vacuum gas oil fractions, deasphalted oils, or other mineral fractions (i.e., less than 1.0 wt % of such fractions).

After forming an asphalt composition by mixing deasphalter rock with bio-oil (and optionally other fractions), the asphalt composition can have a high temperature performance grade of 58 or higher, or 64 or higher, such as up to 76; and/or a low temperature performance grade of −10 or lower, or −16 or lower, or −22 or lower, such as down to −34. Additionally or alternately, the asphalt composition can have a dynamic viscosity at 135° C. of 250 cP or less, such as down to 50 cP. Further additionally or alternately, the asphalt composition can have a penetration at 25° C. of 10 dmm to 50 dmm.

### Upgrading Paving Asphalt to Roofing Asphalt

In various aspects, a paving grade asphalt can be mixed with a bio-oil with a reduced or minimized content of oxidized functional groups to form a base asphalt composition that can be oxidized to form a roofing grade asphalt. The base asphalt composition can include 11 wt % to 25 wt % of the bio-oil and 75 wt % to 89 wt % of the paving grade asphalt, relative to the weight of the base asphalt composition. For purposes of defining the base asphalt composition, the base asphalt composition includes any mineral fractions included in the base asphalt composition. Thus, any mineral distillate fluxes added to the base asphalt composition are considered when determining the properties of the paving grade asphalt that is mixed with the bio-oil. The paving grade asphalt that is used to form the base asphalt composition can have a high temperature performance grade of 58 or higher, such as up to 76.

In an additional aspect, the paving grade asphalt can correspond to a paving grade asphalt formed by mixing deasphalter rock with bio-oil. In this aspect, the base asphalt composition can include any bio-oil used for upgrading the deasphalter rock, as well as all mineral fractions. Thus, in such an aspect, the base asphalt can include 11 wt % to 25 wt % (relative to the weight of the base asphalt) of a bio-oil with a reduced or minimized content of oxidized functional groups, and 75 wt % to 89 wt % of a paving asphalt formed from deasphalter rock, additional bio-oil, and any other mineral fractions. It is noted that the additional bio-oil for upgrading the deasphalter rock may also correspond to bio-oil with a reduced or minimized content of oxidized functional groups.

The base asphalt composition, prior to any air blowing, can have a high temperature performance grade of 52 or less, such as down to 40. Additionally or alternately, the base asphalt composition, prior to any air blowing, can have a kinematic viscosity at 100° C. of 1000 cSt or less, or 800 cSt or less, or 650 cSt or less, such as down to 100 cSt or possibly still lower. It is noted that this is lower than the typical kinematic viscosity for a base asphalt composition that is then air blown to form a roofing asphalt. Having a kinematic viscosity at 100° C. of 1000 cSt or less is an indicator for an asphalt that, when oxidized, will not have a suitable combination of softening point and penetration at 25° C. to qualify as a roofing asphalt. Further additionally or alternately, the base asphalt composition, prior to any air blowing, can have a penetration at 25° C. of 300 dmm to 750 dmm. Still further additionally or alternately, the base asphalt composition, prior to any air blowing, can have a softening point of 20° C. to 40° C.

The base asphalt composition can then be air blown to form a roofing asphalt composition. The roofing asphalt composition can have a high temperature performance grade of 70 or higher, or 82 or higher, or 94 or higher, such as up to 130 or possibly still higher; a penetration at 25° C. of 12 dmm or more, such as up to 25; and a softening point of 99° C. or higher, such as up to 110° C.

Air blowing of the base asphalt composition to form a roofing asphalt composition can be performed in any convenient manner. Optionally, a catalyst can be added to the base asphalt composition to facilitate oxidation. More generally, any convenient method of oxidation can be used, such as oxidation with an oxidizing agent different from oxygen. When air blowing is used, the air blowing can be performed by bubbling air (or another gas flow containing oxygen) through the base asphalt composition at a temperature of 150° C. to 280° C. for a sufficient time to achieve a target softening point. This can correspond to a time between 10 minutes and 10 hours, or between 10 minutes and 6 hours.

### EXAMPLES

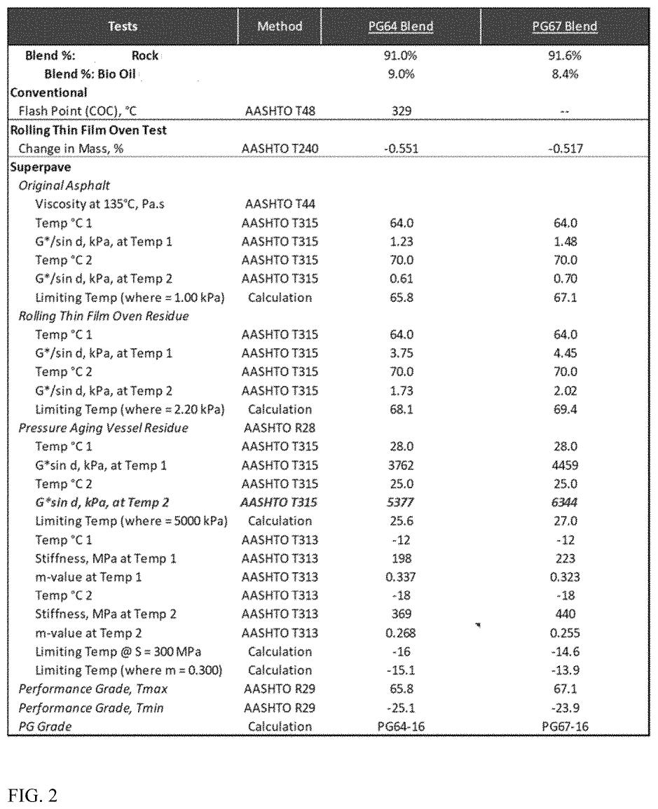

A crude oil with a vacuum gas oil fraction suitable for lubricants production was fractionated to form a vacuum gas oil fraction and a vacuum resid fraction. The vacuum resid fraction was then exposed to solvent deasphalting conditions using propane as a solvent. The deasphalted oil was incorporated into other refinery streams, such as combining a portion of it with the vacuum gas oil fraction for lubricants production. The deasphalter rock fraction was used to form various asphalt compositions by blending the deasphalter rock with corn oil in an amount of either 8.4 wt % or 9.0 wt % relative to the total weight of the asphalt composition. FIG. 1 shows the performance grade for the resulting asphalt compositions. FIG. 2 shows results from characterization of various properties of the resulting asphalt compositions. FIG. 2 also includes the corresponding suitable method for determining the properties.

As shown in FIG. 1, addition of less than 10 wt % of a vegetable oil resulted in asphalt compositions with a performance grade of at least 64-22 on a SUPERPAVE grid. Data point 102 corresponds to the blend including 8.4 wt % corn oil, corresponding to a 64-22 asphalt with regard to just the high temperature performance grade and low temperature performance grade. Data point 104, where 9.0 wt % of corn oil was added, resulted in an asphalt composition with a high temperature performance grade of 67. Based on the additional properties shown in FIG. 2, the performance grade may actually be 64-16, but it is still unexpected that a relatively small amount of a bio-oil was sufficient to upgrade deasphalter rock to a paving grade asphalt.

FIG. 2 provides additional properties for the asphalt composition. The additional properties shown in FIG. 2 correspond to the properties used for determining whether an asphalt composition meets various asphalt specifications within the United States. Based on the values in FIG. 2, the two asphalt compositions satisfy the specifications for most grades of paving asphalt in the U.S.

As shown in FIG. 2, both high temperature and low temperature properties were characterized. High temperature properties were characterized at 64° C. and 70° C. As shown in FIG. 2, the measured G*/sin d values indicate that for the asphalt composition, the dynamic shear rheometer pressure crosses 1.0 kPa at a temperature between 65° C. and 68° C. for both asphalts. Under the conditions for a rolling thin film oven residue test, the temperatures where DSRp crosses 2.2 kPa are slightly higher, but still below 70° C. All of the high temperature values correspond to values that satisfy the high temperature specifications in the U.S. for paving asphalts.

For low temperature properties, pressure aged vessel residue testing was performed at 1) 28° C. and 25° C. and 2) −12° C. and −18° C. As shown in FIG. 2, the dynamic shear rheometer pressures at 25° C. for the two samples were slightly higher in pressure than the allowed specification for some U.S. paving asphalt grade. In particular, based on the G*sind values at 25° C., the asphalt composition did not satisfy the specification for a 64-22 asphalt, and therefore is officially graded as having a low temperature performance grade of −16. However, the DSRp values still satisfy other U.S. paving asphalt grades. For the tests at −12° C. and −18° C., based on the measured values, the temperature where the stiffness pressure crosses 300 MPa is between −14° C. and −16° C., while the temperature where the m value crosses 0.300 is between −13.5° C. and −15.5° C.

### Example 2—Upgrading Paving Asphalt to Roofing Asphalt

A vacuum tower bottoms (VTB) fraction with a performance grade of 64-22 was used as feed for forming a base asphalt mixture. The vacuum tower bottoms fraction was combined with two different types of bio-oils to form various base asphalt compositions that included between 13 wt % to16 wt % of either corn oil or vegetable (soybean) oil. For comparison, an additional base asphalt composition was formed by blending the vacuum tower bottoms fraction with 29 wt % of a brightstock extract fraction. This resulted in base asphalt compositions with a kinematic viscosity at 100° C. of less than 700 cP.

Ferric chloride was then added to the base asphalt composition as an oxidation catalyst at a dosage of 0.15% by weight. The catalyst-containing composition was then oxidized in an air-blowing unit at 260° C. with an air flow rate of 50 L kg⁻¹ h⁻¹ and a stirring rate of 1700 rpm. The oxidation was continued until the softening point of the asphalt reached ˜100° C. with samples taken periodically to monitor the softening point and its rate of change. At the conclusion of the oxidation, the penetration of the final oxidized material was measured. Additionally the stain index of the final materials was measured to determine whether the bio-oil would leach out of the oxidized asphalt. Table 1 shows results from characterization of the base asphalt compositions and the corresponding air blown asphalts for each of the base asphalt compositions that included bio-oil.

TABLE 1
Properties of Base Asphalt Compositions and Corresponding
Air Blown Asphalts

| | Bio-Oil | Starting | Final | Final |
|---|---|---|---|---|
| | Proportion | Viscosity @ | Softening | Penetration @ |
| Bio-Oil | (wt %) | 100° C. (cSt) | Point (° C.) | 25° C. (dmm) |
| Corn Oil | 13.4 | 635 | 100.5 | 12 |
| | 15.7 | 422 | 100.5 | 15 |
| Vegetable Oil | 14.5 | 518 | 100.5 | 14 |

As shown in Table 1, each of the base asphalt compositions had a starting viscosity of less than 650 cSt at 100° C. After air blowing to a final softening point of 100.5° C., the resulting air blown asphalts had penetration values at 25° C. of 12 dmm or greater. Thus, the resulting air blown asphalts satisfied a roofing asphalt specification of having a softening point of greater than 99° C. and a penetration of 12 dmm or greater.

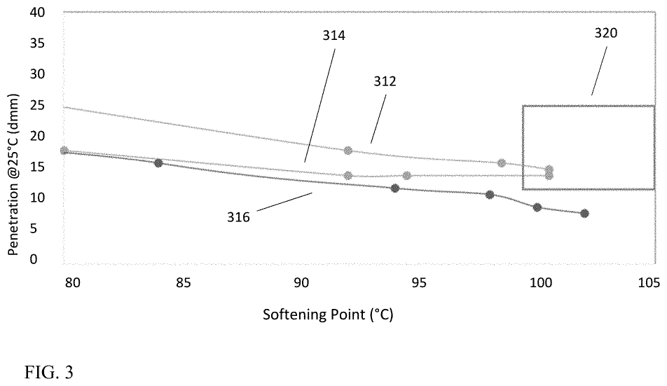

FIG. 3 shows a portion of the oxidation curves for two of the asphalt compositions from Table 1. Oxidation curve 312 corresponds to the oxidation curve for the blend with 15.7 wt % corn oil in the vacuum tower bottoms. Oxidation curve 314 corresponds to the oxidation curve for 14.5 wt % vegetable oil in the vacuum tower bottoms. For comparison, a portion of the oxidation curve for the base asphalt composition including the brightstock extract (curve 316) is also shown. Box 320 represents the target properties based on the ASTM D312 Type IV specification for a roofing asphalt. As shown in FIG. 3, oxidation of the composition including the brightstock extract was not able to achieve the combination of a softening point of greater than 99° C. and a penetration at 25° C. of 12 dmm or more, even though a substantially greater amount of brightstock extract was added to the vacuum tower bottoms.

### Example 3—Reduction in Asphalt Carbon Intensity Based on Incorporation of Bio-Oil

Life cycle assessment was performed on representative mineral asphalts and various types of vegetable oils to determine the impact on carbon intensity of incorporating bio-oils into an asphalt composition. The life cycle assessment was performed using pre-calculated and publicly available GHG emissions values. The carbon intensity values of asphalt products were obtained from the Life Cycle Assessment of Asphalt Binder prepared by ThinkStep for the Asphalt Institute. The carbon intensity values of bio-oils were obtained from the default values in the Greenhouse gases Regulated Emissions and Energy use in Transportation (GREET) model developed by Argonne National Laboratory (values are calculated following ISO 14040.) After determining the carbon intensity of representative asphalt compositions formed from conventional mineral sources, modified carbon intensities were calculated for incorporating 5 wt % or 15 wt % of bio-oil into the asphalt composition.

Table 2 shows the resulting reduction in carbon intensity for incorporation of two types of bio-oils into an asphalt composition. The percentage reductions in carbon intensity shown in Table 2 are relative to an asphalt composition that includes only the corresponding mineral portion. The first row shows incorporation of corn oil, while the second row shows incorporation of soybean oil. The values provided for soybean oil are roughly representative of the reduction in carbon intensity for general types of vegetable oil that are produced via processes where the vegetable oil is the primary product from the processing that forms the vegetable oil. It is noted that the corn oil is a secondary by-product of ethanol production from corn biomass. As a result, the GHG emissions associated with processing of the corn biomass are assigned to the ethanol, and not the corn oil. As a result, the corn oil provides a greater carbon intensity reduction than a conventional vegetable oil. The “min” and “max” values shown in Table 2 reflect the variation in carbon intensity reduction for different types of representative asphalt compositions. The amount of stored biogenic carbon is equivalent to 0.14 and 0.42 kg CO₂/kg for 5% and 15% blending shares respectively.

TABLE 2
Cradle-to-Gate Carbon Intensity Reduction for Bio-Oil in Asphalt

| | Veg. Oil Blending Share (mass %) | | | |
|---|---|---|---|---|
| Vegetable | 5% | | 15% | |
| oil type | Min | Max | Min | Max |
| Corn Oil | 23% | 27% | 68% | 81% |
| | (0.17 kg | (0.17 kg | (0.50 kg | (0.52 kg |
| | CO₂eq/kg) | CO₂eq/kg) | CO₂eq/kg) | CO₂eq/kg) |
| Soybean Oil | 18% | 21% | 53% | 62% |
| | (0.13 kg | (0.14 kg | (0.39 kg | (0.41 kg |
| | CO₂eq/kg) | CO₂eq/kg) | CO₂eq/kg) | CO₂eq/kg) |

As shown in Table 2, addition of relatively low amounts of bio-oil into an asphalt composition can possibly provide substantial reductions in carbon intensity. This is due in part to the negative carbon intensity values for the bio-oils on a “cradle-to-gate” basis. As shown in Table 2, addition of 15 wt % or more of bio-oil to an asphalt composition can reduce the carbon intensity of the asphalt composition by more than half. Based on the values shown in Table 2, for a bio-oil derived as a secondary by-product, addition of close to 20 wt % of bio-oil could potentially result in the full asphalt composition having a negative cradle-to-gate carbon intensity value.

### Comparative Example 4—Addition of 10% or Less Corn Oil to Paving Asphalt

The vacuum tower bottoms fraction (64-22 performance grade) used in Example 2 was used to form an additional asphalt composition by adding 10 wt % corn oil to the vacuum tower bottoms. This resulted in an asphalt composition with a kinematic viscosity at 100° C. of less than 1000 cSt. The asphalt composition was then oxidized under conditions similar to the conditions used in Example 2. FIG. 5 shows the resulting oxidation curve. It is noted that the scale in FIG. 5 is different from FIG. 3.

In FIG. 5, oxidation curve 518 shows how the softening point and penetration at 25° C. changed for the asphalt composition during oxidation to form an oxidized asphalt composition. As shown in FIG. 5, the oxidation curve does not pass through box 520, which corresponds to the box where an asphalt satisfies the ASTM D312 Type IV specification for a roofing asphalt. Instead, by the time the softening point is at 99° C. or higher for the oxidized asphalt composition, the penetration value at 25° C. is too low. This is in contrast to Example 2, where addition of 11% or more of corn oil resulted in an asphalt composition that could be oxidized to form an oxidized asphalt composition that satisfied the ASTM D312 Type IV specification.

Based on the combination of Example 2 and the data in this comparative example, it is understood that addition of 10% or less corn oil to form an asphalt composition with a kinematic viscosity at 100° C. of less than 1000 cSt results in asphalt compositions that cannot be oxidized to form desired roofing asphalt compositions. Similarly, based on the data in Example 2 and this comparative example, it is understood that the vacuum tower bottoms fraction alone, without corn oil addition, could not be oxidized to form an oxidized asphalt composition that satisfies the ASTM D312 Type IV specification.

### ADDITIONAL EMBODIMENTS

### Embodiment 1

An asphalt composition comprising: a hydrocarbonaceous fraction comprising a dynamic viscosity at 130° C. of 8.0 P or more and a high temperature performance grade of 58 or higher; and 2.0 wt % to 20 wt % of a bio-oil, based on a combined weight of the hydrocarbonaceous fraction and the bio-oil, the asphalt composition comprising a high temperature performance grade of 58 or higher and a low temperature performance grade of −10 or lower.

### Embodiment 2

The asphalt composition of Embodiment 1, wherein the asphalt composition comprises 40 wt % or more (or 70 wt % or more) of the hydrocarbonaceous fraction relative to a total weight of the asphalt composition.

### Embodiment 3

The asphalt composition of any of the above embodiments, wherein the hydrocarbonaceous fraction comprises a high temperature performance grade of 70 or higher, or wherein the hydrocarbonaceous fraction comprises a low temperature performance grade of −4 or higher, or a combination thereof.

### Embodiment 4

The asphalt composition of any of the above embodiments, wherein the asphalt composition further comprises 1.0 wt % to 50 wt % of a vacuum resid fraction relative to a total weight of the asphalt composition, the vacuum resid fraction comprising 10 wt % or more of n-heptane asphaltenes, 20 wt % or more of micro carbon residue, or a combination thereof.

### Embodiment 5

The asphalt composition of any of the above embodiments, i) wherein the asphalt composition further comprises 1.0 wt % to 10 wt % of a deasphalted oil fraction, a vacuum gas oil fraction, or a combination thereof, relative to a total weight of the asphalt composition, and wherein the asphalt composition comprises a greater weight percentage of the bio-oil than the weight percentage of the deasphalted oil fraction, the vacuum gas oil fraction, or the combination thereof; or ii) wherein the asphalt composition comprises less than 1.0 wt % of a deasphalted oil fraction, a vacuum gas oil fraction, or a combination thereof.

### Embodiment 6

The asphalt composition of any of the above embodiments, wherein the hydrocarbonaceous fraction comprises a) a density at 15° C. of 1.10 g/cm³ to 1.25 g/cm³; b) an n-heptane insolubles content of 25 wt % to 75 wt %; c) a hydrogen content of 6.5 wt % to 8.4 wt %; d) a micro carbon residue content of 40 wt % to 75 wt %; or e) a combination of two or more of a)-d).

### Embodiment 7

The asphalt composition of any of the above embodiments, wherein the hydrocarbonaceous fraction comprises a deasphalter rock fraction formed by solvent deasphalting using a C₄₊ deasphalting solvent.

### Embodiment 8

An asphalt composition comprising: an asphalt fraction comprising a kinematic viscosity at 100° C. of 1000 cSt or less and a high temperature performance grade of 58 or higher; and 11 wt % to 25 wt % of a bio-oil based on a total weight of the asphalt fraction and the bio-oil, the asphalt composition comprising 5.0 wt % or less of an oxidized bio-oil relative to a weight of the asphalt composition, the asphalt composition comprising a high temperature performance grade of 52 or lower and a penetration at 25° C. of 300 dmm or lower.

### Embodiment 9

The asphalt composition of Embodiment 8, wherein the asphalt fraction comprising a kinematic viscosity at 100° C. of 1000 cSt or more comprises: a hydrocarbonaceous fraction comprising a dynamic viscosity at 130° C. of 8.0 P or more and a high temperature performance grade of 58 or higher; and 2.0 wt % to 20 wt % of an additional bio-oil, based on a combined weight of the hydrocarbonaceous fraction and the additional bio-oil, the asphalt fraction comprising a low temperature performance grade of −10° C. or lower.

### Embodiment 10

The asphalt composition of Embodiment 8 or 9, wherein the bio-oil comprises 10 wt % or more of esters relative to a weight of the bio-oil, or wherein the bio-oil comprises 10 wt % or more of triglycerides relative to a weight of the bio-oil, or a combination thereof.

### Embodiment 11

A method for producing an oxidized asphalt composition, according to any of Embodiments 8 to 10, comprising: mixing i) an asphalt fraction comprising a kinematic viscosity at 100° C. of 1000 cSt or less and a high temperature performance grade of 58 or higher, and ii) 11 wt % to 25 wt % of a bio-oil based on a total weight of the asphalt fraction and the bio-oil, the asphalt composition comprising 5.0 wt % or less of oxidized bio-oil relative to a weight of the asphalt composition, to form an asphalt composition, the asphalt composition comprising a high temperature performance grade of 52 or lower and a penetration at 25° C. of 300 dmm or lower; and oxidizing the asphalt composition to form an oxidized asphalt composition comprising a penetration at 25° C. of 12 dmm or more and a softening point of 99° C. or higher.

### Embodiment 12

The method for producing an oxidized asphalt composition of Embodiment 11, wherein the oxidized asphalt composition comprises a high temperature performance grade of 82 or higher.

### Embodiment 13

An oxidized asphalt composition formed according to the method of Embodiment 11 or 12.

### Embodiment 14

The asphalt composition of any of Embodiments 1-10 or 13, wherein the asphalt composition comprises a carbon intensity that is lower than a carbon intensity of the hydrocarbonaceous fraction by at least 20%.

### Embodiment 15

The asphalt composition of any of Embodiments 1-10, 13, or 14, wherein the bio-oil comprises 5.0 wt % or less of oxidized functional groups relative to a weight of the bio-oil.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. An asphalt composition comprising:
a hydrocarbonaceous fraction comprising a dynamic viscosity at 130° C. of 8.0 P or more and a high temperature performance grade of 58 or higher; and
2.0 wt % to 20 wt % of a bio-oil, based on a combined weight of the hydrocarbonaceous fraction and the bio-oil,
the asphalt composition comprising a high temperature performance grade of 58 or higher and a low temperature performance grade of −10 or lower.

2. The asphalt composition of claim 1, wherein the asphalt composition comprises 40 wt % or more of the hydrocarbonaceous fraction relative to a total weight of the asphalt composition.

3. The asphalt composition of claim 1, wherein the asphalt composition comprises 70 wt % or more of the hydrocarbonaceous fraction relative to a total weight of the asphalt composition.

4. The asphalt composition of claim 1, wherein the hydrocarbonaceous fraction comprises a high temperature performance grade of 70 or higher, or wherein the hydrocarbonaceous fraction comprises a low temperature performance grade of −4 or higher, or a combination thereof.

5. The asphalt composition of claim 1, wherein the asphalt composition further comprises 1.0 wt % to 50 wt % of a vacuum resid fraction relative to a total weight of the asphalt composition, the vacuum resid fraction comprising 10 wt % or more of n-heptane asphaltenes, 20 wt % or more of micro carbon residue, or a combination thereof.

6. The asphalt composition of claim 1, wherein the asphalt composition further comprises 1.0 wt % to 10 wt % of a deasphalted oil fraction, a vacuum gas oil fraction, or a combination thereof, relative to a total weight of the asphalt composition.

7. The asphalt composition of claim 6, wherein the asphalt composition comprises a greater weight percentage of the bio-oil than the weight percentage of the deasphalted oil fraction, the vacuum gas oil fraction, or the combination thereof.

8. The asphalt composition of claim 1, wherein the asphalt composition comprises less than 1.0 wt % of a deasphalted oil fraction, a vacuum gas oil fraction, or a combination thereof.

9. The asphalt composition of claim 1, wherein the hydrocarbonaceous fraction comprises a) a density at 15° C. of 1.10 g/cm³ to 1.25 g/cm³; b) an n-heptane insolubles content of 25 wt % to 75 wt %; c) a hydrogen content of 6.5 wt % to 8.4 wt %; d) a micro carbon residue content of 40 wt % to 75 wt %; or e) a combination of two or more of a)-d).

10. The asphalt composition of claim 1, wherein the hydrocarbonaceous fraction comprises a deasphalter rock fraction formed by solvent deasphalting using a C₄₊ deasphalting solvent.

11. The asphalt composition of claim 1, wherein the asphalt composition comprises a carbon intensity that is lower than a carbon intensity of the hydrocarbonaceous fraction by at least 20%.

12. An asphalt composition comprising:
an asphalt fraction comprising a kinematic viscosity at 100° C. of 1000 cSt or less and a high temperature performance grade of 58 or higher; and
11 wt % to 25 wt % of a bio-oil based on a total weight of the asphalt fraction and the bio-oil, the asphalt composition comprising 5.0 wt % or less of an oxidized bio-oil relative to a weight of the asphalt composition,
the asphalt composition comprising a high temperature performance grade of 52 or lower and a penetration at 25° C. of 300 dmm or lower.

13. The asphalt composition of claim 12, wherein the asphalt fraction comprising a kinematic viscosity at 100° C. of 1000 cSt or more comprises:
a hydrocarbonaceous fraction comprising a dynamic viscosity at 130° C. of 8.0 P or more and a high temperature performance grade of 58 or higher; and
2.0 wt % to 20 wt % of an additional bio-oil, based on a combined weight of the hydrocarbonaceous fraction and the additional bio-oil,
the asphalt fraction comprising a low temperature performance grade of −10 or lower.

14. The asphalt composition of claim 11, wherein the bio-oil comprises 10 wt % or more of esters relative to a weight of the bio-oil, or wherein the bio-oil comprises 10 wt % or more of triglycerides relative to a weight of the bio-oil, or a combination thereof.

15. The asphalt composition of claim 11, wherein the bio-oil comprises 5.0 wt % or less of oxidized functional groups relative to a weight of the bio-oil.

16. The asphalt composition of claim 11, wherein the asphalt composition comprises a carbon intensity that is lower than a carbon intensity of the asphalt fraction by at least 20%.

17. A method for producing an oxidized asphalt composition, comprising:
mixing i) an asphalt fraction comprising a kinematic viscosity at 100° C. of 1000 cSt or less and a high temperature performance grade of 58 or higher, and ii) 11 wt % to 25 wt % of a bio-oil based on a total weight of the asphalt fraction and the bio-oil, the asphalt composition comprising 5.0 wt % or less of oxidized bio-oil relative to a weight of the asphalt composition, to form an asphalt composition, the asphalt composition comprising a high temperature performance grade of 52 or lower and a penetration at 25° C. of 300 dmm or lower; and
oxidizing the asphalt composition to form an oxidized asphalt composition comprising a penetration at 25° C. of 12 dmm or more and a softening point of 99° C. or higher.

18. The method for producing an oxidized asphalt composition of claim 15, wherein the oxidized asphalt composition comprises a high temperature performance grade of 82 or higher.

19. The method for producing an oxidized asphalt composition of claim 15, wherein the asphalt composition comprises a carbon intensity that is lower than a carbon intensity of the asphalt fraction by at least 20%.

20. An asphalt composition comprising:
an asphalt fraction comprising a kinematic viscosity at 100° C. of 1000 cSt or less and a high temperature performance grade of 58 or higher, the asphalt fraction comprising
a hydrocarbonaceous fraction comprising a dynamic viscosity at 130° C. of 8.0 P or more and a high temperature performance grade of 58 or higher; and
2.0 wt % to 20 wt % of an additional bio-oil, based on a combined weight of the hydrocarbonaceous fraction and the additional bio-oil,
the asphalt fraction comprising a low temperature performance grade of −10° C. or lower; and
11 wt % to 25 wt % of a bio-oil based on a total weight of the asphalt fraction and the bio-oil, the asphalt composition comprising 5.0 wt % or less of an oxidized bio-oil relative to a weight of the asphalt composition,
the asphalt composition comprising a high temperature performance grade of 52 or lower and a penetration at 25° C. of 300 dmm or lower.
